(19) United States
(12) Patent Application Publication
(10) Pub. No.: US 2007/0123069 A1
(43) Pub. Date: May 31, 2007

(54) Clip ribbon and apparatus for splicing surface mounted device carrier tapes

(76) Inventors: Je-Ir Choi, Suwon-si (KR); Sung-Tae Kim, Geumwang-up (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/637,267

(22) Filed: Dec. 12, 2006

Related U.S. Application Data
(63) Continuation of application No. PCT/KR05/01758, filed on Jun. 10, 2005.

(30) Foreign Application Priority Data
Jun. 12, 2004 (KR) 10-2004-0043347

(51) Int. Cl. H01R 12/00

(52) U.S. Cl. 439/71

(57) ABSTRACT

Disclosed is a clip ribbon and apparatus for splicing surface mount device carrier tapes. The clip ribbon has a plurality of clips used for splicing carrier tapes are connected to one another in a line. The apparatus for splicing device carrier tapes has a tool for splicing the carrier tapes with a clip supplied from a roll of the clip ribbon. The tool is fixed to a frame to improve the speed and accuracy of the splicing process.

### CROSS-REFERENCE TO RELATED PATENT APPLICATIONS

This application is a continuation application under 35 U.S.C. § 365(c) of International Application No. PCT/KR2005/001758, filed Jun. 10, 2005 designating the United States. International Application No. PCT/KR2005/001758 was published in English as WO2005/122666 A1 on Dec. 22, 2005. This application further claims the benefit of the earlier filing dates under 35 U.S.C. § 365(b) of Korean Patent Application No. 10-2004-0043347 filed Jun. 12, 2004. This application incorporates herein by reference the International Application No. PCT/KR2005/001758 including the International Publication No. WO2005/122666 A1 and the Korean Patent Application No. 10-2004-0043347 in their entirety.

### BACKGROUND

1. Field of the Invention

The present invention relates to a clip ribbon and apparatus for splicing surface mount device carrier tapes, and more particularly, to a clip ribbon in which a plurality of clips used for splicing carrier tapes are connected to one another in a line to prevent the clips from missing, and an apparatus for splicing device carrier tapes in which a tool for splicing the carrier tapes is fixed to a frame to thereby improve the speed and accuracy of the splicing process.

2. Discussion of Related Technology

Contact electrodes are first formed on a printed circuit board (PCB), a cream solder is then applied thereto, and devices such as chips are finally surface mounted thereon by means of a chip mounter. At this time, the required devices need to be fed continuously. To continuously feed the devices, additional equipment called a tape feeder is used. The tape feeder is mounted with a device drum around which a carrier tape with the devices included therein is wound in the form of a reel. That is, the devices to be mounted on the printed circuit board are first included in the carrier tape which in turn is wound on the device drum, and the tape feeder unwinds the carrier tape from the device drum to feed the devices to the chip mounter.

As shown in FIG. 6, the carrier tape 50 takes the shape of a band including holders 52 in which the devices will be are received. In particular, index holes 51 are formed in a line along an edge on the carrier tape 50 in a longitudinal direction. The index holes 51 are used to unwind the carrier tape from the device drum at a certain pitch, and it is formed at regular intervals and can be formed on one or both sides of the carrier tape depending on the carrier tape standards.

On the other hand, if the carrier tape wound on the device drum has been completely unwound from the device drum, the device drum should be replaced with a new one. Since the feeding of devices is stopped while the device drum is replaced, a part or entire process of manufacturing the printed circuit board including a process of operating the chip mounter should be stopped. Thereafter, to continuously feed the devices, a last portion of a carrier tape unwound from the used device drum should be spliced to an initial portion of a carrier tape unwound from the new device drum.

In the past, a clip 10 is used to splice the two carrier tapes 50 and 50′, as shown in FIGS. 7 and 8. The clip 10 is formed with a plurality of through holes 11 at the same interval as that of the index holes 51, and with teeth 12 on edges of the through holes. Therefore, to splice the two carrier tapes 50 and 50′, the clip 10 should be coupled with the adjacent carrier tapes 50 and 50′ such that the teeth 12 can be inserted in the corresponding index holes 51 at the adjacent end portions of the two carrier tapes. Then, the clip 10 should also be pressed by a separate splicing tool (not shown) such that the teeth 12 are bent, as shown in FIG. 8.

However, the operations for exchanging the device drum are frequently performed in a production line several hundred times or more a day, while the clip is fed one by one and the splicing tool is a hand-operated tool which should be manually operated by a worker. Thus, there is a problem in that working efficiency becomes lower. Further, even a skilled worker has a great difficulty in replacing the device drum and splicing the carrier tapes in a short time. In addition, since the size of clip becomes smaller in proportion to the size of the device, there is another problem in that a missing amount of the clips provided apiece is increased in storage or use thereof.

The discussion in this section is to provide general background information, and does not constitute an admission of prior art.

### SUMMARY

One aspect of the invention provides a method of connecting two tapes, which comprises: providing a first tape and a second tape, the first tape comprising a first end, the second tape comprising a second end, wherein each of first and second tapes comprises a plurality of holes that are substantially linearly arranged, and wherein each of the first and second tapes is configured to carry a plurality of articles thereon; providing a plurality of connector strips, each of which extends in a longitudinal direction thereof, wherein the plurality of connector strips are arranged along the longitudinal direction and integrated together, wherein the plurality of connector strips comprise a first connector strip comprising a plurality of engaging protrusions; arranging the first tape and the second tape such that the first end and the second end oppose each other; engaging at least one of the plurality of engaging protrusions with at least one of the holes of the first tape; engaging at least one of the plurality of engaging protrusions with at least one of the holes of the second tape; and disintegrating the first connector strip from the remainder of the plurality of connector strip.

In the foregoing method, the plurality of connector strips may comprise a second connector strip immediately neighboring the first connector strip, wherein a connecting portion interconnects and is interposed between the first and second connector strips, wherein disintegrating may comprise cutting at the connecting portion between the first and second connector strips, and wherein, after cutting, part of the connecting portion may belong to the first or second connector strips. The plurality of connector strips may be connected to a band extending alongside the plurality of connector strips, and wherein disintegrating may comprise disconnecting the first connector strip from the band. Disintegrating may be performed when the first connector strip is engaged with the first and second tapes.

Another aspect of the invention provides a roll of tape connector strips for interconnecting two tapes, which comprises: a plurality of connector strips, each of which extends in a longitudinal direction, wherein the plurality of connector strips are arranged along the longitudinal direction and integrated together; wherein the plurality of connector strips comprise a first connector strip and a second connector strip immediately neighboring the first connector strip; wherein the first connector strip comprises a plurality of protrusions, at least part of which are configured to be engaged with a plurality of holes formed in a tape.

In the foregoing roll, the plurality of connector strips may comprise means for facilitating separating the first connector strip from the second connector strip, and wherein the means for facilitating may be located between the first and second connector strips. The roll may comprise a bridge interconnecting the first and second connector strips, wherein each of the first and second connector strips may have a first width measured in a width direction perpendicular the longitudinal direction, wherein the bridge may have a second width measured in the width direction, and wherein the second width may be smaller than the first width. The roll may comprise two bridges, each of which interconnects the first and second connector strips, and wherein two bridges may be spaced therebetween. The roll may further comprise a band extending alongside the plurality of connector strips, wherein the plurality of connector strips may be connected to the band so as to be integrated together.

Still another aspect of the invention provides an apparatus for connecting two tapes, which comprises: a stage configured to support a first tape carrying a plurality of articles thereon and a second tape carrying a plurality of articles thereon; and a feeder for a connector strip configured to interconnect the first and second tapes, the feeder comprising the foregoing roll, wherein the feeder is configured to move the first connector strip such that the plurality of protrusions of the first connector strip are aligned with the plurality of holes of the first second tapes.

In the foregoing apparatus, the apparatus may further comprise means for engaging at least one of the plurality of protrusions with at least one of the holes of the first tape and for engaging at least one of the plurality of protrusions with at least one of the holes of the second tape. The apparatus may further comprise a cutter configured to disintegrate the first connector strip from the second connector strip.

An aspect of the present invention provides a clip ribbon for splicing carrier tapes, which can prevent a clip from missing and rapidly splice the carrier tapes.

An aspect of the present invention provides a splicing apparatus capable of rapidly fulfilling a process of splicing the carrier tapes using the clip ribbon.

An aspect of the invention provides a clip ribbon for splicing device carrier tapes comprising a plurality of clips arranged in a longitudinal direction at regular intervals, each clip being formed into a rectangular thin plate and formed with a plurality of through holes, each through hole being formed with teeth on an edge thereof, each tooth protruding from a surface of the clip; and a tape with a plurality of clips whose surface opposite to the surface of the clips on which the teeth are formed is attached to the tape. The clip ribbon is a band-shaped thin plate that can be wound on a roll and is formed with a plurality of through holes in a line in a longitudinal direction, and a plurality of teeth are formed around an edge of the through hole and protrude from one surface of the clip ribbon. At this time, a plurality of notches may be formed on the clip ribbon at regular intervals in a longitudinal direction.

An aspect of the invention provides a clip ribbon for splicing device carrier tapes is characterized by comprising: a plurality of clip sections arranged in a longitudinal direction at regular intervals, each clip being formed into a rectangular thin plate and formed with a plurality of through holes, each through hole being formed with teeth on an edge thereof, each tooth protruding from a surface of the clip; a plurality of cutting sections extending laterally toward the clip sections, respectively; and a winding section connected to the respective cutting sections and extending in a longitudinal direction of the plurality of the clip sections.

An aspect of the invention provides an apparatus for splicing carrier tapes characterized by comprising: a frame; a device drum rotatably supported on the frame for winding a carrier tape with surface mount devices received therein and a plurality of index holes formed in a line in a longitudinal direction; a clip drum rotatably supported on the frame for winding a clip ribbon with a plurality of clips connected to one another in a line in a longitudinal direction, each clip being formed with a plurality of through holes in a line in a longitudinal direction and formed with teeth protruding downward from an edge of the through hole; a splicing tool supported on the frame for splicing a last end of a carrier tape to an initial end of the other carrier tape by pressing downward an upper surface of the clip to deform the teeth, the clip being disposed in such a manner that the teeth formed around at least one of the plurality of through holes of the clip unwound from the clip drum are inserted in the index hole formed at the last end of the carrier tape unwound from the device drum and that the teeth formed around at least one of the other through holes of the clip are inserted in the index hole formed at the initial end of the other carrier tape unwound from another device drum; and a cutter fixed to the splicing tool for cutting a connecting portion between the clip used for splicing the last end of the carrier tape to the initial end of the other carrier tape to be spliced by using the splicing tool and the next clip.

In particular, the splicing tool may be characterized by comprising: a fixing portion fixed to the frame at a lower side thereof and including first and second hinges formed to be spaced apart from each other on an upper side thereof; an upper jaw including one end hinged to the first hinge formed on the upper side of the fixing portion and the other end with a pressing portion provided thereon, the pressing portion being used to press downward the upper surface of the clip disposed in such a manner that the teeth formed around at least one of the plurality of through holes of the clip unwound from the clip drum are inserted in the index hole formed at the last end of the carrier tape unwound from the device drum and that the teeth formed around at least one of the other through holes of the clip are inserted in the index hole formed at the initial end of the other carrier tape unwound from another device drum; a lower jaw fixed to the frame and placed below the pressing portion of the upper jaw to support the clip thereon, the lower jaw being engaged with the pressing portion of the upper jaw to deform the teeth of the clip when the upper jaw is pivoted on the first hinge of the fixing portion; a pressing handle having an end pivotably hinged to the upper jaw; a return link having one end pivotably hinged to the pressing handle and the other end pivotably hinged to the second hinge of the fixing portion; and elastic means having one end connected to the return link and the other end fixed to the fixing portion to apply a force to the return link in a direction in which the pressing portion of the upper jaw is far away from the lower jaw; wherein the cutter is configured to cut the connecting portion between the clips of the clip ribbon when one of the clips is pressed to splice the last end of the carrier tape to the initial end of the other carrier tape to be spliced by using the splicing tool.

Further, the apparatus for splicing the carrier tapes may further comprise a feeding sprocket rotatably fixed to the frame and formed with a plurality of pins formed on a circumferential surface at the same interval as that between the adjacent through holes of the clip of the clip ribbon to guide movement of the clip ribbon; an oscillating cam fixed to be concentric with the feeding sprocket; a latched lever having one end brought into contact with the outer circumferential surface of the oscillating cam and a center portion hinged to the frame; and a rocking roller installed on the frame to be movable upward and downward while brought into contact with the other end of the latched lever. Preferably, the lower jaw has index pins protruding upward from an upper surface thereof and inserted in the through holes of the clip, and the upper jaw has inserting holes in which the index pins are inserted.

In addition, the splicing tool may further comprise a pusher plate hinged to the lower jaw to press the clip ribbon supported on the lower jaw, whereby the clip ribbon is brought into close contact with the lower jaw. The apparatus for splicing the carrier tapes may further comprise: a guide rail fixed on an upper surface of the frame perpendicular to a conveying direction of the carrier tape; and a splicing tool slidably mounted onto the guide rail.

The apparatus for splicing the carrier tapes may further comprise: a feeding sprocket rotatably fixed to the frame and formed with a plurality of pins formed on a circumferential surface at the same interval as that between the adjacent through holes of the clip of the clip ribbon to guide movement of the clip ribbon; a fixed disc fixed to the frame to be coaxial with the feeding sprocket and formed with a plurality of grooves on a coaxial circle with the feeding sprocket on an outer surface thereof at regular intervals; and a spin drum fixed between the feeding sprocket and the fixed disc to be concentric with the feeding sprocket and provided with a spring and a spin ball at a location thereof corresponding to the grooves of the fixed disc to allow the spin ball to be placed in the grooves of the fixed disc by means of an elastic force of the spring, wherein the spin ball is placed in the next groove of the fixed disc when the feeding sprocket is rotated by an angular displacement from a groove to the next groove.

The apparatus for splicing the carrier tapes is may further comprise elastic pressing means which is fixed to the frame and provides a frictional force to a side surface of the clip drum to prevent the clip drum from rotating by a rotational force below a predetermined limit. Preferably, the elastic pressing means comprises a housing formed with a through hole on an edge portion thereof in an axial direction and fixed to the frame to be positioned at a side surface of the clip drum; a spring placed in the through hole; a ball placed at an opening of the through hole such that a portion of the ball protrudes out of the housing by means of an elastic force of the spring to apply a certain force to the clip drum, and an adjusting nut placed in the through hole to adjust the elastic force of the spring. The cutter may be fixed upward onto the lower jaw, the upper jaw further comprise an elastic projection at a location corresponding to the cutter, the lower jaw has index pins protruding upward from an upper surface thereof and inserted in the through holes of the clip, and the upper jaw has inserting holes in which the index pins are inserted. The apparatus for splicing the carrier tapes may further comprise a friction disc which is fixed to the frame and provides a frictional force to a side surface of the device drum to prevent the device drum from rotating by a rotational force below a predetermined limit.

### BRIEF DESCRIPTION OF THE DRAWINGS

FIG. 1 is a perspective view of a clip ribbon for splicing surface mount device carrier tapes according to an embodiment of the present invention.

FIG. 2 is a sectional view of a clip shown in FIG. 1.

FIGS. 3 and 4 are perspective views of a clip ribbon for splicing surface mount device carrier tapes according to an embodiment of the present invention.

FIG. 5 is a perspective view of a clip ribbon for splicing surface mount device carrier tapes according to an embodiment of the present invention.

FIG. 6 is a perspective view showing an example of a surface mount device carrier tape.

FIG. 7 is a view illustrating a method for splicing the carrier tapes using an exemplary clip.

FIG. 8 is a sectional view of the carrier tapes spliced with each other by the exemplary clip.

FIG. 9 is a front view of an apparatus for splicing the surface mount device carrier tapes according to an embodiment of the present invention.

FIG. 10 is a left side view of the embodiment shown in FIG. 9.

FIG. 11 is a detailed view showing a state where a splicing tool shown in FIG. 9 is opened.

FIG. 12 is a detail view showing a state where the splicing tool shown in FIG. 9 is closed.

FIG. 13 is a plan view of the embodiment shown in FIG. 9.

FIG. 14 is a rear view of the embodiment shown in FIG. 9.

FIG. 15 is an enlarged view of a cutter shown in FIG. 14.

FIG. 16 is a front view of an apparatus for splicing surface mount device carrier tapes according to an embodiment of the present invention.

FIG. 17 is a left side view of the embodiment shown in FIG. 16.

FIG. 18 is an enlarged view of an “A” portion of FIG. 18.

FIG. 19 is a rear view of the embodiment shown in FIG. 16.

FIG. 20 is an enlarged view of a feeding sprocket shown in FIG. 19.

FIG. 21 is a sectional view taken along line B-B of FIG. 20.

FIG. 22 is an enlarged view of a cutter shown in FIG. 19.

### EXPLANATION OF REFERENCE NUMERALS IN THE DRAWINGS

100: Clip 200: Tape

510: Device drum 520: Clip drum

530: Frame 600: Splicing tool

700: Guide rail C: Clip ribbon

### DETAILED DESCRIPTION OF EMBODIMENTS

Hereinafter, various embodiments of a clip ribbon for splicing surface mount device carrier tapes according to an aspect of the present invention will be described in detail with reference to accompanying drawings.

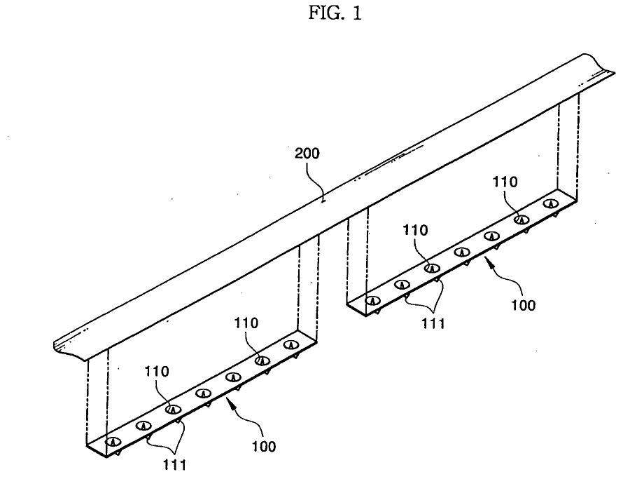

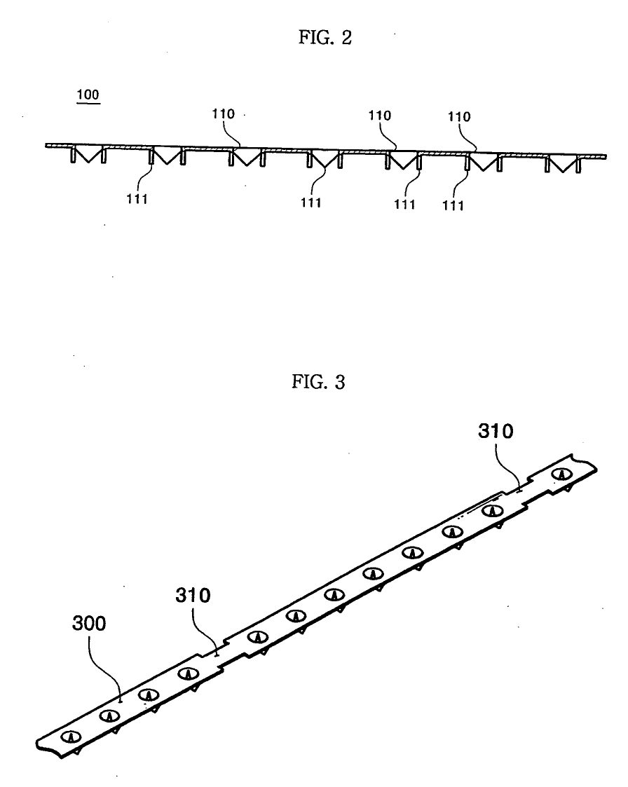

FIG. 1 is a perspective view of a clip ribbon for splicing surface mount device carrier tapes according to an embodiment of the present invention, and FIG. 2 is a sectional view of a clip shown in FIG. 1.

The clip ribbon comprises a plurality of clips or connector strips 100 and a tape 200. The clips 100 are formed of a rectangular thin plate and have a plurality of through holes 110 formed in a line along a longitudinal direction. Preferably, each of the through holes 110 has the same size as and is formed at the same interval as that of each index hole formed on the surface mount device carrier tape. As seen from a sectional view of FIG. 2, teeth or protrusions 111 are formed on an edge of the through hole 111 to protrude from one surface of the thin plate. The teeth 111 can be formed simultaneously when the through holes 110 are formed. For example, if a pin with a cross-shaped tip penetrates the thin plate, the thin plate is cut out and four sections pushed out by the pin become the teeth protruding from one surface of the thin plate.

A plurality of clips 100 are attached onto a surface of the tape 200, which is opposite to a surface on which the teeth 111 are formed. Preferably, the plurality of clips are arranged at regular intervals for the standardization thereof. Further, the plurality of clips are preferably arranged in a line along a longitudinal direction. The plurality of clips 100 attached to the tape 200 as described above are formed into a single clip ribbon. Since the clips 100 provided in the form of the clip ribbon are attached to the tape 200, there is no risk that the clips might be missing. Further, the clips can be used to rapidly splice the carrier tapes, together with an apparatus for splicing the surface mount device carrier tapes according to the present invention to be described later.

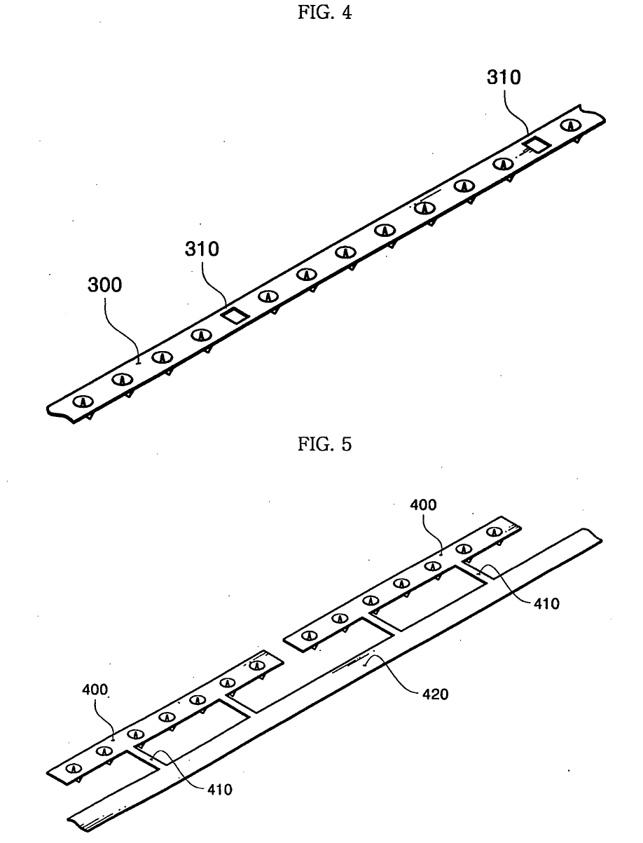

FIGS. 3 and 4 are perspective views of a clip ribbon for splicing surface mount device carrier tapes according to an embodiment of the present invention. In this embodiment, a clip ribbon is a band-shaped thin plate 300 that can be wound on a roll, and it is formed with a plurality of through holes in a line in a longitudinal direction. A plurality of teeth are formed around an edge of each through hole and protrude from one surface of the thin plate. Preferably, notch sections 310 with notches are formed on the clip ribbon at regular intervals in a longitudinal direction. FIG. 3 shows an example in which each of the notch sections 310 has one branch, while FIG. 4 shows another example in which each of the notch sections 310 has two branches. In this embodiment, since one clip section formed between the adjacent notch sections 310 corresponds to the a single exemplary clip as described above, the notch section 310 should be cut for the next splicing process after the clip section is fixed to the carrier tapes to connect two carrier tapes with each other.

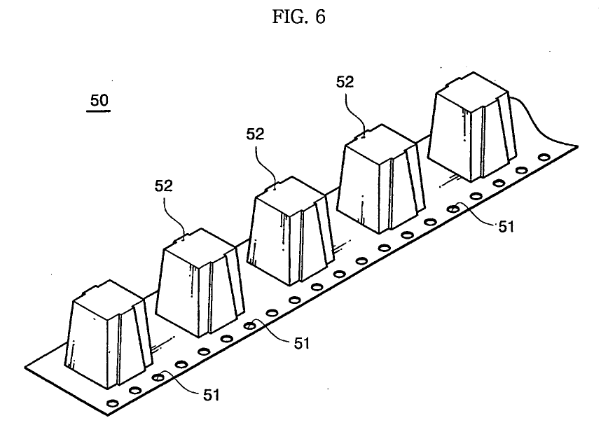

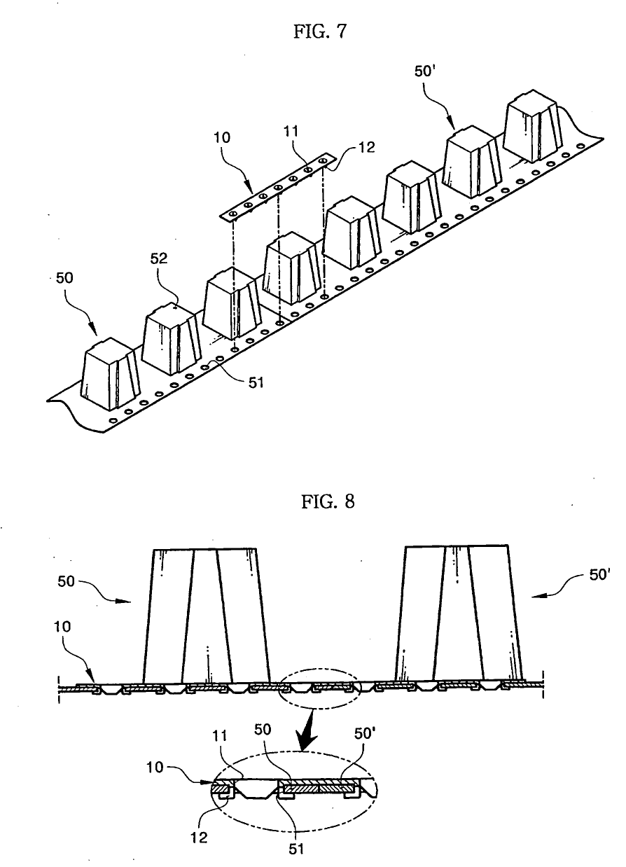

FIG. 5 is a perspective view of a clip ribbon for splicing surface mount device carrier tapes according to an embodiment of the present invention. The clip ribbon of this embodiment comprises a plurality of clip sections 400 and cutting sections 410, and a winding section or band 420. Each of the clip sections 400 is formed into a rectangular thin plate and formed with a plurality of through holes. Further, teeth are formed around an edge of each through hole and protrude from one surface of the clip ribbon. In addition, each of the cutting sections 410 extends laterally toward the clip section 400, and the winding section 420 connected to the cutting section 410 extends in a longitudinal direction of the clip section 400. The winding section 420 enables the clip ribbon of this embodiment to be wound in the form of a roll. In this embodiment, the plurality of clip sections are preferably disposed in a line in a longitudinal direction. Also, in this embodiment, since the winding section 420 is useless after the clip section has been fixed to the carrier tape, the cutting section 410 is also preferably cut away. In the previous embodiment, when the notch section 310 is cut in a state where the clip ribbon is attached to the carrier tape, a portion of a lateral edge of the carrier tape is also cut. In this embodiment, however, since the cutting sections 410 extend widthwise from the clip section 400, the carrier tape is not damaged at all even though the cutting section 410 is cut in a state where the clip section is attached to the carrier tape.

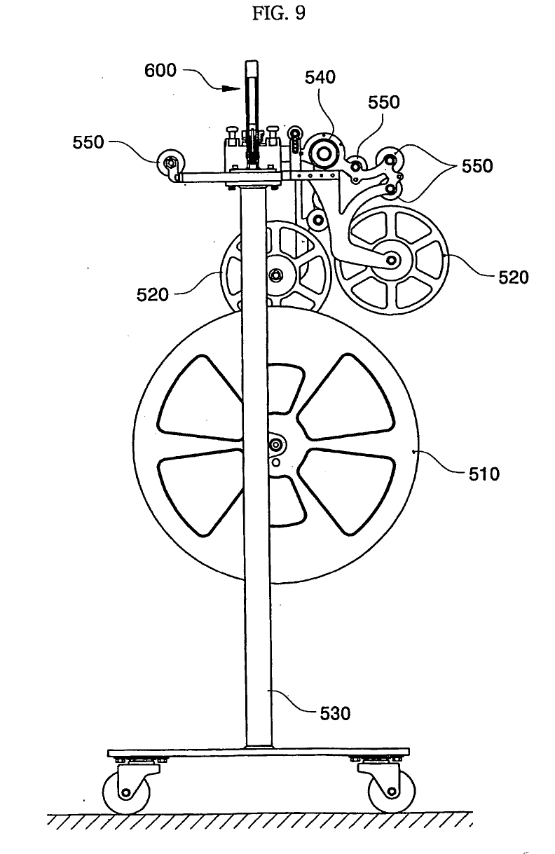

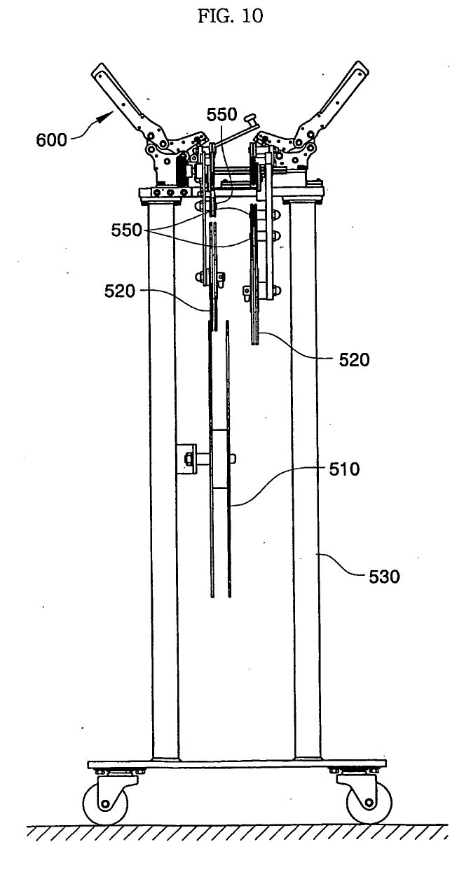

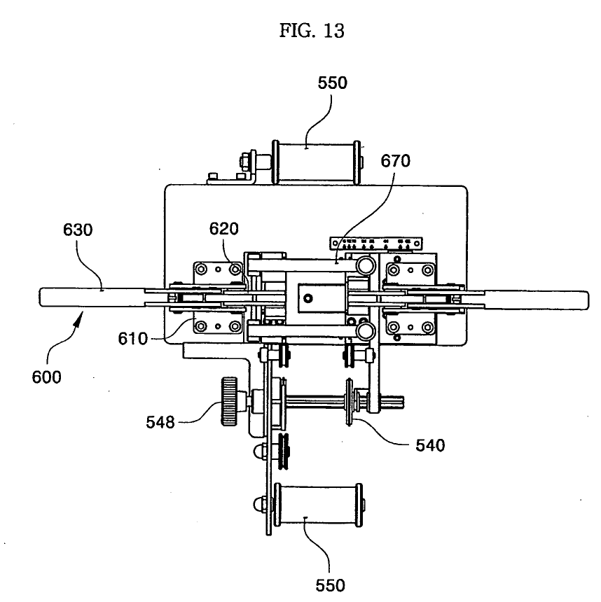

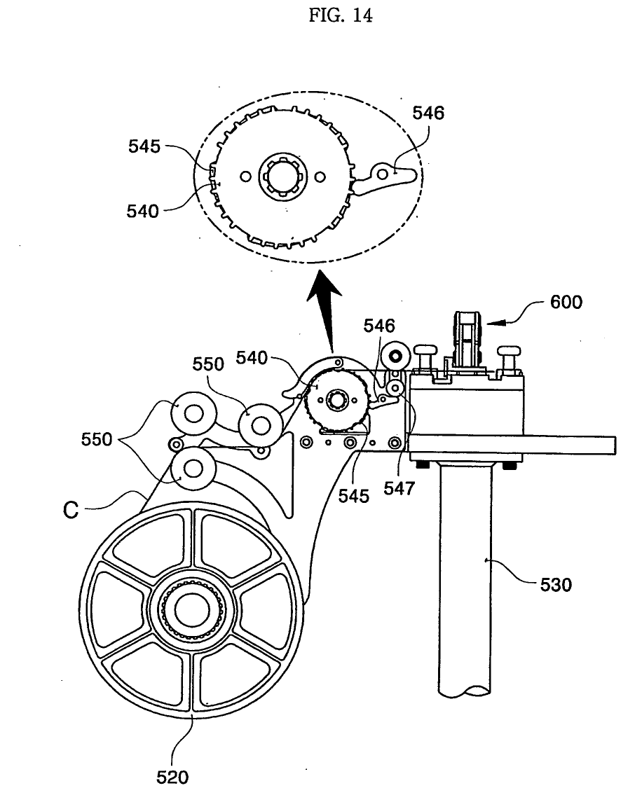

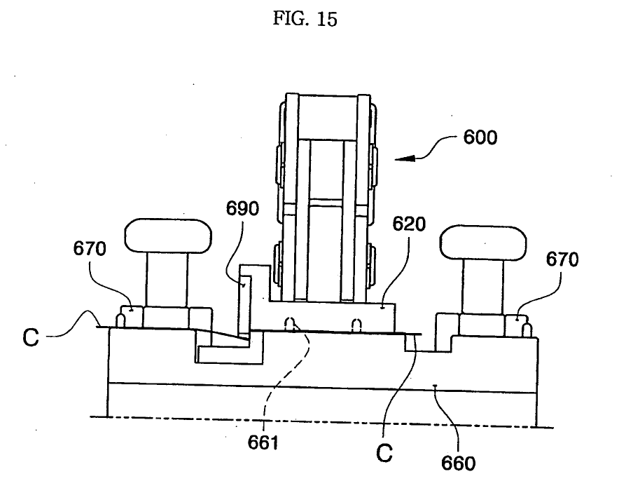

Hereinafter, certain embodiments of the apparatus for splicing the surface mount device carrier tapes according to another aspect of the present invention will be described in detail with reference to accompanying drawings. FIG. 9 is a front view of an apparatus for splicing the surface mount device carrier tapes according to an embodiment of the present invention, FIG. 10 is a left side view of the apparatus shown in FIG. 9, FIG. 13 is a plane view of the embodiment shown in FIG. 9, FIG. 14 is a rear view of the embodiment shown in FIG. 9, and FIG. 15 is an enlarged view of a cutter shown in FIG. 14.

The apparatus of this embodiment comprises a device drum 510, clip drums 520, a frame 530, splicing tools 600, and a cutter 690. The carrier tape with the devices included therein is wound on the device drum 510 which in turn is rotatably supported on the frame 530. The device drum is rotated to feed the carrier tape wound thereon to the splicing tool 600. A pair of clip drums 520 are provided. Each of the clip drums 520 is wound with the clip ribbon C and rotatably supported on the frame 530. Although it is not necessary to provide a pair of clip drums, a pair of clip drums are preferably provided to splice the carrier tapes with the index holes formed on opposite sides thereof. The clip drums 520 are also rotated to feed the clip ribbons C wound thereon to the splicing tools 600, respectively. Although it is described that the ribbon clip C may be any one of the clip ribbons previously described in the above embodiments, any kinds of the clip ribbons may be used so long as they are shaped as a band and can continuously feed the clips.

A pair of splicing tools 600 are arranged on an upper surface of the frame 530 to face each other. The clip ribbons C unwound from the pair of clip drums 520 are fed to the splicing tools, respectively. More precisely, each of clip ribbons is fed to a position where the clip ribbon can be pressed by upper and lower jaws of the corresponding splicing tool 600, which will be described later. Further, the carrier tape unwound from the device drum 510 passes between the pair of splicing tools 600. At this time, an edge portion of the carrier tape in which the index holes are formed should overlap with the position where the clip ribbons are fed.

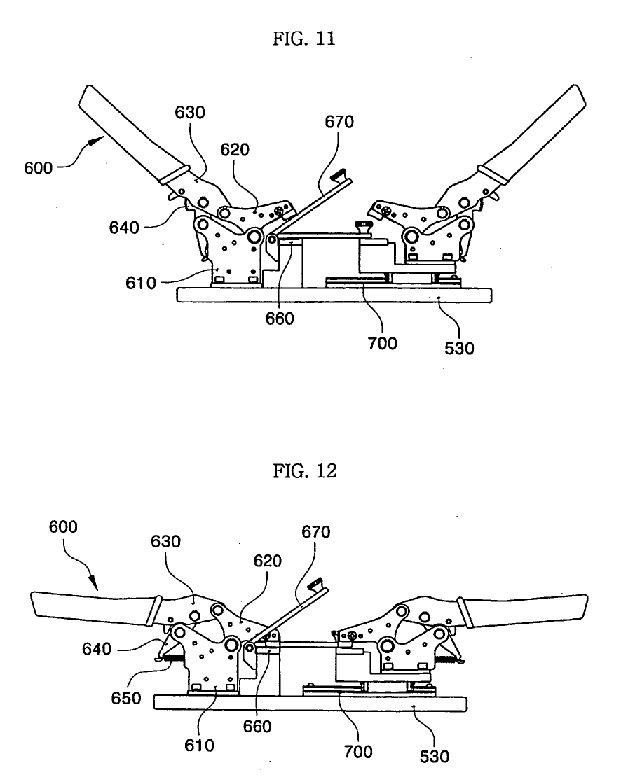

As shown in FIGS. 11 and 12, each of the splicing tools 600 comprises a fixing portion 610, an upper jaw 620, a pressing handle 630, a return link 640, an elastic member 650, and a lower jaw 660. An upper side of the fixing portion 610 is formed with first and second hinges, while a lower side of the fixing portion is fixed to the upper surface of the frame 530. One end of the upper jaw 620 is hinged to the first hinge formed on the upper side of the fixing portion 610, while the other end thereof is provided with a pressing portion for pressing the clip of the clip ribbon C. The lower jaw 660 is fixed onto the frame 530 such that it is engaged with the pressing portion formed on another end of the upper jaw 620 to press the clip of the clip ribbon C when the upper jaw 620 is pivoted on the first hinge of the fixing portion 610. The pressing handle 630 is hinged to the other en of the upper jaw 620. The return link 640 is hinged on the pressing handle 630 and the second hinge formed on the upper side of the fixing portion 610. One end of the return link 640 is connected to one end of the elastic member 650. The other end of the elastic member 650 is fixed to the fixing section 610. As described above, the fixing portion, the upper jaw, the pressing handle and the return link are hinged to each other to construct a four bar linkage. At this time, if the pressing handle 630 is operated, the upper jaw 620 is moved together with the handle so that the splicing tool can be in an open state as shown in FIG. 11 and in a closed state as shown in FIG. 12.

In particular, in the closed state of the splicing tool, the lower jaw 660 fixed to the upper surface of the frame 530 is engaged with the upper jaw 620. At this time, the lower jaw 660 supports upward the clip of the clip ribbon placed between the upper and lower jaws 620 and 660, and the upper jaw 620 presses the clip downward. Accordingly, the carrier tape is fed such that a widthwise end of the carrier tape with the index holes formed therein is placed between the upper and lower jaws 620 and 660, and the clip ribbon C is also fed together with the carrier tape such that the through holes of the clip overlap with the index hole. Then, if the splicing tool is in the closed state as shown in FIG. 12 by pushing the pressing handle 630 downward, the clip is pressed by means of the upper and lower jaws 620 and 660 and the teeth of the clip are then bent as shown in FIG. 8 such that two opposite ends of the adjacent carrier tapes can be connected to each other by means of the clip. If a force applied to the pressing handle is removed in the closed state, the splicing tool 600 is returned to the open state by a restoring force of the elastic member 650. At this time, to fix the clip to the carrier tapes at a correct position, as shown in FIG. 15, the lower jaw 660 preferably has index pins 661 formed at the same interval as that of the through holes of the clip. The index pins 661 protrude upward from an upper surface of the lower jaw 660. Also, inserting holes are preferably formed on the upper jaw 620 such that the index pins 661 can be inserted therein when the upper and lower jaws 620 and 660 are engaged with each other. As shown in FIG. 15, when the slicing tool 600 is in the closed state, the index pins 661 of the lower jaw 660 are inserted in the inserting holes of the upper jaw 620. Thus, the upper jaw can be accurately engaged with the lower jaw by means of the index pins.

To smoothly feed the carrier tape and the clip ribbon C, guide rollers 550 are preferably installed on the frame 530. The guide rollers 550 are shaped as a rotatable drum, and preferably are disposed at positions where moving paths for the carrier tape and clip ribbon C are curved. Further, a feeding sprocket 540 with pins disposed at regular intervals is preferably installed on the frame 530 such that the pins can be inserted into the index holes of the carrier tape and the through holes of the clip ribbon C. The feeding sprocket 540 is to transfer the carrier tape or clip ribbon C at a correct pitch toward the splicing tool 600. As shown from the rear view of FIG. 14, an oscillating cam 545 is concentrically fixed to the feeding sprocket 540 to be rotated along with the feeding sprocket. In addition, the center of a latched lever 546 whose one end is brought into contact with an outer circumferential surface of the oscillating cam 545 is hinged to the frame 530. A rocking roller 547 is also installed on the frame 530 such that it can be brought into contact with the other end of the latched lever 546 to be moved upward and downward according to the motion of the latched lever. If the latched lever 546 oscillates angularly according to the profile of the oscillating cam 545 rotating along with the feeding sprocket 540, the rocking roller 547 brought into contact with the other end of the latched lever 546 is reciprocated upward and downward. Accordingly, in a case where the clip ribbon C passes over the rocking roller 547, the clip ribbon C is periodically moved upward and downward. The oscillating cam 545, the latched lever 546 and the rocking roller 547 are to enable the index pins 661 to be conveniently inserted into the through holes of the clip in a case where the index pins are formed on the lower jaw 660 of the splicing tool 600.

In the meantime, if the clip ribbon C used in this embodiment has the same shape as that of the clip ribbon for splicing the carrier tapes according to the aforementioned embodiment of the present invention, a process of splicing the carrier tapes is finished by removing only the tape after the splicing tool 600 is returned to the open state. If the clip ribbon C used in this embodiment has the same shape as that of the clip ribbon for splicing the carrier tapes according the aforementioned embodiment of the present invention, it is preferred that the cutter 690 be installed on the upper jaw 620 of the splicing tool 600. The cutter 690 is shaped as a knife blade and preferably disposed across the clip of the clip ribbon C to cut the notch section 310 of the clip. Since the cutter 690 cuts the notch section of the clip ribbon C when the splicing tool 600 is in the closed state as shown in FIG. 15, a process of splicing the carrier tapes can be finished without any additional post-processing. At this time, since the teeth of the clip ribbon have been already inserted in the index holes formed on the ends of two carrier tapes, the two carrier tapes can be partially cut away. Even though the two carrier tape are cut together with the clip ribbon, however, a cut portion of the carrier tape is restricted to a portion of the widthwise edge, and the function of the carrier tape can be still maintained. If the clip ribbon C used in this embodiment has the same shape as that of the clip ribbon for splicing the carrier tapes according the aforementioned embodiment of the present invention, it is preferred that the cutter 690 be disposed in a longitudinal direction of the clip section 400 to cut the cutting section 410. As already described, in such a case, it is possible to prevent the carrier tape from be cut together with the clip ribbon.

According to this embodiment, a pair of the splicing tools 600 and a pair of clip drums 620 for providing the clip ribbons C to the splicing tools are provided. Thus, the pair of splicing tools 600 can be used simultaneously in a case where the carrier tapes with the index holes formed on both widthwise ends thereof are spliced, and only one desired splicing tool 600 can be used in a case where the carrier tapes with the index holes formed on only one widthwise end thereof are spliced. Furthermore, to prevent the carrier tape from coming off the lower jaw 660, it is preferable to provide a pusher plate 670. The pusher plate 670 is disposed perpendicular to a feeding direction of the carrier tape and configured such that one end is hinged and the other end is detachably fixed. Preferably, the pusher plate is disposed at the same level as the upper surface of the lower jaw 660.

In addition, a guide rail 700 is preferably installed on the upper surface of the frame 530 in a widthwise direction of the carrier tape such that at least one of the pair of splicing tools 600 can be slidably installed on the guide rail 700. The reason is that a variety of carrier tapes can be controlled such that a widthwise end of the carrier tape can be placed between the upper and lower jaws of the splicing tool. In this embodiment so configured, a last end of the carrier tape wound on the device drum and an initial end of a carrier tape wound on a new device drum are spliced with the clip of the clip ribbon wound on the clip drum using the splicing tool, and the spliced carrier tape can be then fed to equipment, e.g. a tape feeder or chip mounter, for the next works.

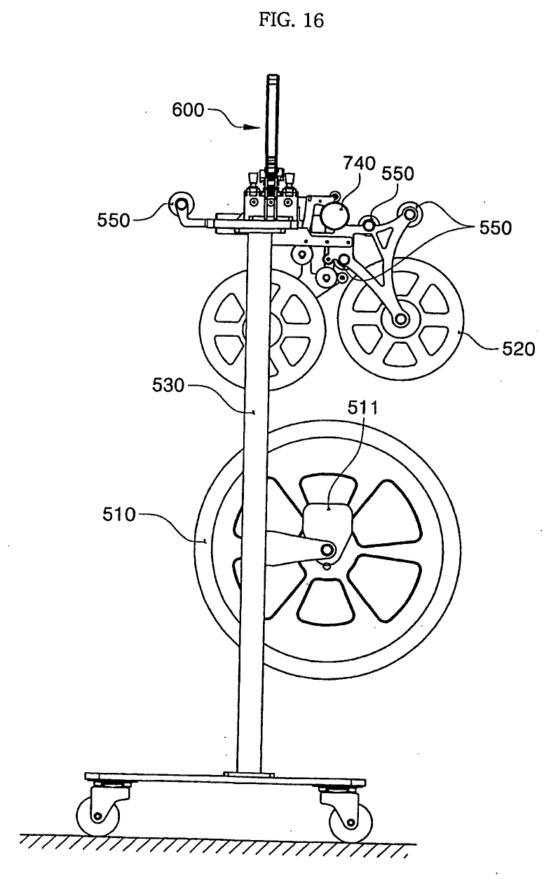

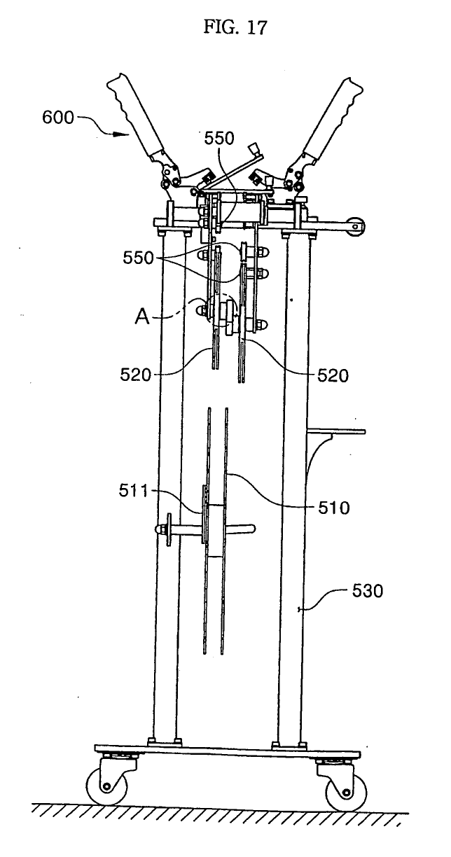

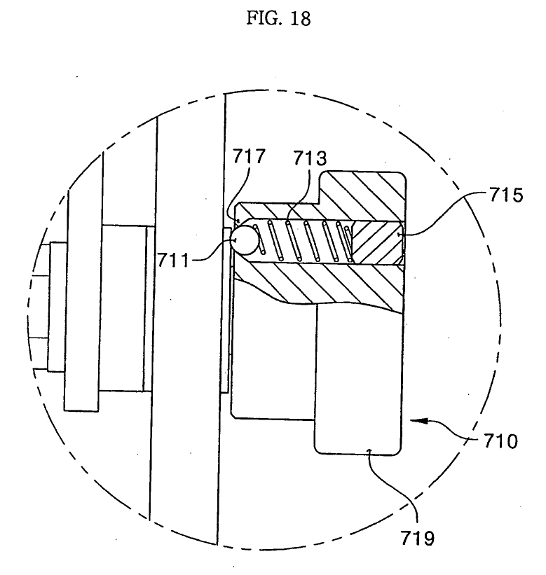

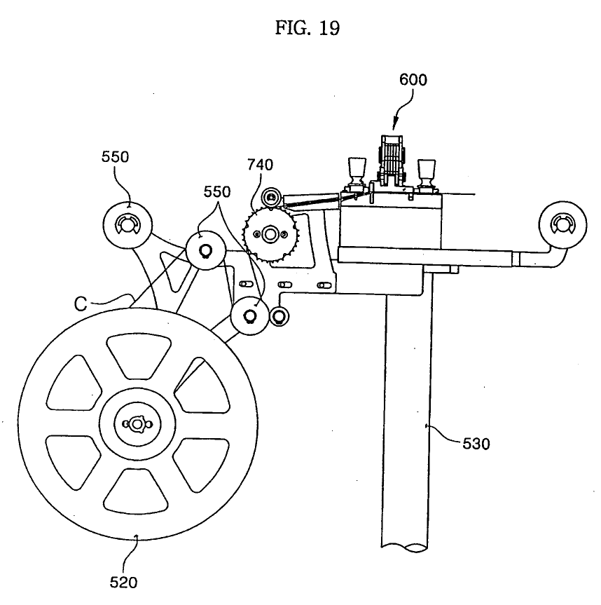

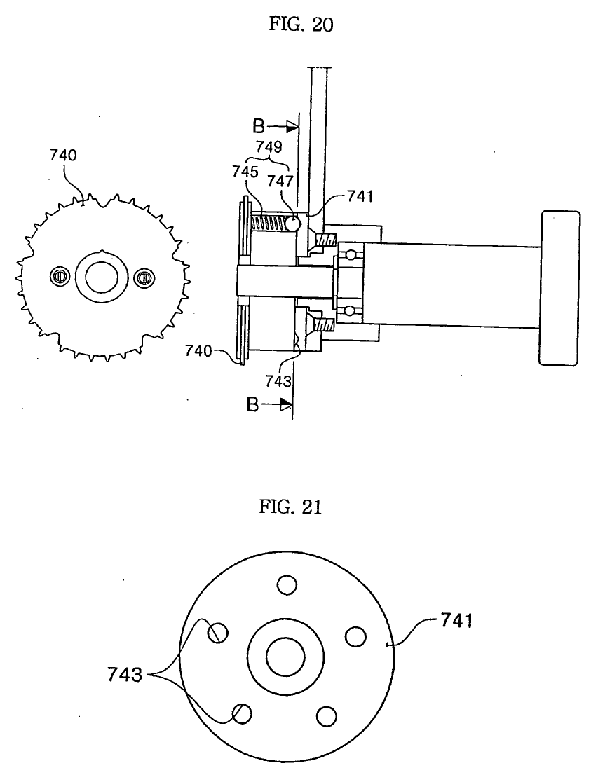

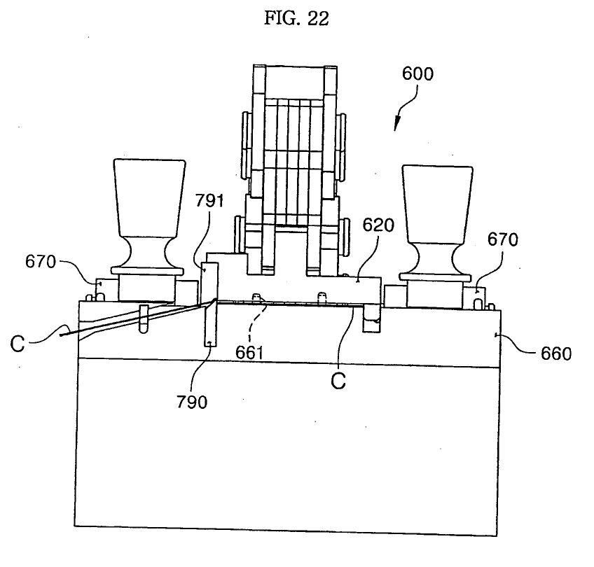

FIG. 16 is a front view of an apparatus for splicing surface mount device carrier tapes according to an embodiment of the present invention, FIG. 17 is a left side view of the embodiment shown in FIG. 16, FIG. 18 is an enlarged view of an “A” portion of FIG. 17, FIG. 19 is a rear view of the embodiment shown in FIG. 16, FIG. 20 is an enlarged view of a feeding sprocket shown in FIG. 19, FIG. 21 is a sectional view taken along line B-B of FIG. 20, and FIG. 22 is an enlarged view of a cutter shown in FIG. 19.

As compared with the apparatus for splicing the surface mount device carrier tapes shown in FIG. 9, the apparatus of this embodiment further comprises a friction disc 511 and a ball plunger 710. Further, this embodiment employs a feeding sprocket 740, a fixed disc 741 and a spin drum 749 to feed the clip to the splicing tool 600, instead of the feeding sprocket 540, the oscillating cam 545, the latched lever 546 and the rocking roller 547. Further, an installation position of the cutter 790 is different from that of the cutter in the apparatus for splicing the surface mount device carrier tapes shown in FIG. 9. Accordingly, since the structure of this embodiment is the same as that of the embodiment shown in FIG. 9 except the above, the detailed description thereof will be omitted herein by referring to the corresponding description on the apparatus for splicing the surface mount device carrier tapes shown in FIG. 9.

The friction disc 511 is fixed to the frame 530 in such a state where it is brought into contact with a side surface of the device drum 510. Accordingly, the friction disc 511 provides the side surface of the device drum 510 with a friction force to prevent the device drum 510 from rotating by a certain rotational force below a predetermined limit. Since the device drum 510 is rotatably supported on the frame 530, the device drum 510 is rotated in a case where the carrier tape is fed to the splicing tool 600. In such a case, the device drum is continuously rotated by its own inertia even when the feeding of carrier tapes to the splicing tool 600 is stopped. However, in a case where the friction disc 511 is installed on the side surface of the device drum 510, a certain frictional force is applied to the device drum 510. Therefore, if the feeding of carrier tapes is stopped and a rotational force is not applied to the device drum 510, the rotation of the device drum 510 is also stopped. On the other hand, in a case where the carrier tapes are fed to the splicing tool 600, a rotational force is again applied to the device drum 510. At this time, since the rotational force becomes larger than the frictional force generated between the friction disc 511 and the device drum 510, the device drum 510 is again rotated.

To prevent the clip drum 520 from rotating by a certain rotational force below a predetermined limit, the ball plunger 710 is fixed to the frame 530 to apply certain load to a side surface of the clip drum 520. The ball plunger 710 includes a housing 719, a ball 711, a spring 713, and an adjusting nut 715. The housing 719 is formed with a through hole on an edge portion thereof and fixed to the frame 530 to be positioned at a side surface of the clip drum 520. The ball 711, the spring 713 and the adjusting nut 715 are placed within the through hole of the housing 719. An elastic force of the spring 713 is applied to the clip drum 520 via the ball 711. The adjusting nut 715 can be screwed to the housing. Therefore, since the elastic force of the spring 713 can be adjusted using the adjusting nut 715, a force applied to the clip drum 520 can also be adjusted. Further, a projection 717 for preventing the ball 711 from getting removed from the ball plunger 719 can be formed at an opening of the through hole.

Since the clip drum 520 is also rotatably supported on the frame 530 in the same manner as the device drum 510, the clip drum 520 is still continuously rotated by its own inertia even though the feeding of the clip ribbons C to the splicing tool 600 is stopped. However, if the ball plunger 719 is installed to apply a force to the clip drum 520, the rotation of the clip drum 520 is stopped when the feeding of the clip ribbons C is stopped.

In the apparatus for splicing the surface mount device carrier tapes shown in FIG. 9, in order to sequentially feed the clip to the splicing tool 600 one by one, the feeding sprocket 540, the oscillating cam 545, the latched lever 546 and the rocking roller 547 are used. In this embodiment, however, the feeding sprocket 740, the fixed disc 741 and the spin drum 749 are used.

Similar to the apparatus for splicing the surface mount device carrier tapes shown in FIG. 9, a plurality of pins are formed on an outer circumferential surface of the feeding sprocket 740 at regular angular intervals such that they can be inserted into the index holes of the carrier tape and the through holes of the clip ribbon C. Further, the feeding sprocket is rotatably installed to the frame 530. The fixed disc 741 is fixed to the frame 530 to be concentric with the feeding sprocket 740. Further, grooves 743 are formed on a coaxial circle with the feeding sprocket 740 on an outer surface of the fixed disc 741 at regular intervals. The interval between the grooves 743 is set such that one clip can be fed to the splicing tool 600 when the feeding sprocket 740 is rotated by an angular displacement from a groove to the next groove. Thus, if five grooves 743 are formed on the fixed disc 741 as illustrated in this embodiment, five clips can be fed to the splicing tool 600 per rotation of the feeding sprocket 740. The spin drum 749 is fixed between the feeding sprocket 740 and the fixed disc 741 to be concentric with the feeding sprocket 740. Therefore, once the sprocket 740 is rotated, the spin drum 749 is also rotated together with the feeding sprocket. The spin drum 749 is provided with a spring 745 and spin ball 747 at a location thereof corresponding to the grooves 743 of the fixed disc 741. The spin ball 747 is placed in one of the grooves 743 of the fixed disc 741 by means of an elastic force of the spring 745. Once the sprocket 740 is rotated, the spin drum 749 is also rotated together with the feeding sprocket. Therefore, the spin ball 747 placed in the groove 743 of the fixed disc 741 gets removed from the groove 743 and moved along the certain circle on the outer surface of the fixed disc 741. At this time, if the feeding sprocket 747 is further rotated to the next groove 743, the spin ball 747 is placed in the next groove 743, so that one clip is fed to the splicing tool 600. Accordingly, the clips can be fed to the splicing tool 600 one by one.

In this embodiment, the cutter 790 is installed on the lower jaw 660. The shape of the cutter 790 is the same as that of the cutter 690 in the embodiment shown in FIG. 9, and the cutter 790 is also disposed in a widthwise direction of the clip ribbon C. Further, an elastic projection 791 is installed on the upper jaw 620 at a location corresponding to the cutter 790. Accordingly, when the splicing tool 600 is in a closed state, the elastic projection 791 pushes the clip ribbon C downward such that the notch section of the clip ribbon C can be cut by the cutter 790. Herein, it is preferred that the elastic projection 791 be made of an elastic material such as urethane.

It is intended that the embodiments of the present invention described above and illustrated in the drawings should not be construed as limiting the technical spirit of the present invention. The scope of the present invention is not limited to the embodiments but should be defined only by the appended claims. It is apparent to those skilled in the art that various changes and modifications can be made thereto without departing from the technical spirit of the present invention. Therefore, various changes and modifications fall within the scope of the present invention so far as they are obvious to those skilled in the art.

According to embodiments of the present invention so configured, since a plurality of clips are attached to the splicing tape or connected to one another, it is possible to prevent the clips from missing. Further, an effort to manually feed very small-sized clips apiece can be saved, a plurality of clips can be wound in a roll shape, and the clips can be continuously fed. Therefore, the convenience of use is increased. In addition, since the splicing apparatus in which the splicing tool used only for splicing the carrier tapes is fixed to the frame is provided, a process of splicing the carrier tapes can be markedly easily and rapidly performed. Accordingly, since it is possible to minimize a period of time for which a process of manufacturing the printed circuit board is interrupted, production efficiency is markedly enhanced and loss due to the interruption of the manufacturing process can also be reduced.

What is claimed is:

1. A method of connecting two tapes, the method comprising:
providing a first tape and a second tape, the first tape comprising a first end, the second tape comprising a second end, wherein each of first and second tapes comprises a plurality of holes that are substantially linearly arranged, and wherein each of the first and second tapes is configured to carry a plurality of articles thereon;
providing a plurality of connector strips, each of which extends in a longitudinal direction thereof, wherein the plurality of connector strips are arranged along the longitudinal direction and integrated together, wherein the plurality of connector strips comprise a first connector strip comprising a plurality of engaging protrusions;
arranging the first tape and the second tape such that the first end and the second end oppose each other;
engaging at least one of the plurality of engaging protrusions with at least one of the holes of the first tape;
engaging at least one of the plurality of engaging protrusions with at least one of the holes of the second tape; and
disintegrating the first connector strip from the remainder of the plurality of connector strip.

2. The method of claim 1, wherein the plurality of connector strips comprises a second connector strip immediately neighboring the first connector strip, wherein a connecting portion interconnects and is interposed between the first and second connector strips, wherein disintegrating comprises cutting at the connecting portion between the first and second connector strips, and wherein, after cutting, part of the connecting portion belongs to the first or second connector strips.

3. The method of claim 1, wherein the plurality of connector strips are connected to a band extending alongside the plurality of connector strips, and wherein disintegrating comprises disconnecting the first connector strip from the band.

4. The method of claim 1, wherein disintegrating is performed when the first connector strip is engaged with the first and second tapes.

5. A roll of tape connector strips for interconnecting two tapes, the roll comprising:
a plurality of connector strips, each of which extends in a longitudinal direction, wherein the plurality of connector strips are arranged along the longitudinal direction and integrated together;
wherein the plurality of connector strips comprise a first connector strip and a second connector strip immediately neighboring the first connector strip;
wherein the first connector strip comprises a plurality of protrusions, at least part of which are configured to be engaged with a plurality of holes formed in a tape.

6. The roll of claim 5, wherein the plurality of connector strips comprises means for facilitating separating the first connector strip from the second connector strip, and wherein the means for facilitating is located between the first and second connector strips.

7. The roll of claim 5, wherein the roll comprises a bridge interconnecting the first and second connector strips, wherein each of the first and second connector strips has a first width measured in a width direction perpendicular the longitudinal direction, wherein the bridge has a second width measured in the width direction, and wherein the second width is smaller than the first width.

8. The roll of claim 5, wherein the roll comprises two bridges, each of which interconnects the first and second connector strips, and wherein two bridges are spaced therebetween.

9. The roll of claim 5, further comprising a band extending alongside the plurality of connector strips, wherein the plurality of connector strips are connected to the band so as to be integrated together.

10. An apparatus for connecting two tapes, comprising:
a stage configured to support a first tape carrying a plurality of articles thereon and a second tape carrying a plurality of articles thereon; and
a feeder for a connector strip configured to interconnect the first and second tapes, the feeder comprising the roll of claim 5, wherein the feeder is configured to move the first connector strip such that the plurality of protrusions of the first connector strip are aligned with the plurality of holes of the first second tapes.

11. The apparatus of claim 10, further comprising means for engaging at least one of the plurality of protrusions with at least one of the holes of the first tape and for engaging at least one of the plurality of protrusions with at least one of the holes of the second tape.

12. The apparatus of claim 10, further comprising a cutter configured to disintegrate the first connector strip from the second connector strip.

13. A clip ribbon for splicing device carrier tapes, comprising:
a plurality of clips arranged in a longitudinal direction at regular intervals, each clip being formed into a rectangular thin plate and formed with a plurality of through holes, each through hole being formed with teeth on an edge thereof, each tooth protruding from a surface of the clip; and
a tape with a plurality of clips whose surface opposite to the surface of the clips on which the teeth are formed is attached to the tape.

14. A clip ribbon for splicing device carrier tapes, wherein the clip ribbon is a band-shaped thin plate that can be wound on a roll and is formed with a plurality of through holes in a line in a longitudinal direction, and a plurality of teeth are formed around an edge of the through hole and protrude from one surface of the clip ribbon.

15. The clip ribbon as claimed in claim 14, wherein a plurality of notches are formed on the clip ribbon at regular intervals in a longitudinal direction.

16. A clip ribbon for splicing device carrier tapes, comprising:
a plurality of clip sections arranged in a longitudinal direction at regular intervals, each clip being formed into a rectangular thin plate and formed with a plurality of through holes, each through hole being formed with teeth on an edge thereof, each tooth protruding from a surface of the clip;
a plurality of cutting sections extending laterally toward the clip sections, respectively; and
a winding section connected to the respective cutting sections and extending in a longitudinal direction of the plurality of the clip sections.

17. An apparatus for splicing carrier tapes, comprising:
a frame;
a device drum rotatably supported on the frame for winding a carrier tape with surface mount devices received therein and a plurality of index holes formed in a line in a longitudinal direction;
a clip drum rotatably supported on the frame for winding a clip ribbon with a plurality of clips connected to one another in a line in a longitudinal direction, each clip being formed with a plurality of through holes in a line in a longitudinal direction and formed with teeth protruding downward from an edge of the through hole;
a splicing tool supported on the frame for splicing a last end of a carrier tape to an initial end of the other carrier tape by pressing downward an upper surface of the clip to deform the teeth, the clip being disposed in such a manner that the teeth formed around at least one of the plurality of through holes of the clip unwound from the clip drum are inserted in the index hole formed at the last end of the carrier tape unwound from the device drum and that the teeth formed around at least one of the other through holes of the clip are inserted in the index hole formed at the initial end of the other carrier tape unwound from another device drum; and
a cutter fixed to the splicing tool for cutting a connecting portion between the clip used for splicing the last end of the carrier tape to the initial end of the other carrier tape to be spliced by using the splicing tool and the next clip.

18. The apparatus as claimed in claim 17, wherein the splicing tool comprises:
a fixing portion fixed to the frame at a lower side thereof and including first and second hinges formed to be spaced apart from each other on an upper side thereof;
an upper jaw including one end hinged to the first hinge formed on the upper side of the fixing portion and the other end with a pressing portion provided thereon, the pressing portion being used to press downward the upper surface of the clip disposed in such a manner that the teeth formed around at least one of the plurality of through holes of the clip unwound from the clip drum are inserted in the index hole formed at the last end of the carrier tape unwound from the device drum and that the teeth formed around at least one of the other through holes of the clip are inserted in the index hole formed at the initial end of the other carrier tape unwound from another device drum;
a lower jaw fixed to the frame and placed below the pressing portion of the upper jaw to support the clip thereon, the lower jaw being engaged with the pressing portion of the upper jaw to deform the teeth of the clip when the upper jaw is pivoted on the first hinge of the fixing portion;
a pressing handle having an end pivotably hinged to the upper jaw;
a return link having one end pivotably hinged to the pressing handle and the other end pivotably hinged to the second hinge of the fixing portion; and
elastic means having one end connected to the return link and the other end fixed to the fixing portion to apply a force to the return link in a direction in which the pressing portion of the upper jaw is far away from the lower jaw;
wherein the cutter is configured to cut the connecting portion between the clips of the clip ribbon when one of the clips is pressed to splice the last end of the carrier tape to the initial end of the other carrier tape to be spliced by using the splicing tool.

19. The apparatus as claimed in claim 18, further comprising:
a feeding sprocket rotatably fixed to the frame and formed with a plurality of pins formed on a circumferential surface at the same interval as that between the adjacent through holes of the clip of the clip ribbon to guide movement of the clip ribbon;
an oscillating cam fixed to be concentric with the feeding sprocket;
a latched lever having one end brought into contact with the outer circumferential surface of the oscillating cam and a center portion hinged to the frame; and
a rocking roller installed on the frame to be movable upward and downward while brought into contact with the other end of the latched lever,
wherein the lower jaw has index pins protruding upward from an upper surface thereof and inserted in the through holes of the clip, and the upper jaw has inserting holes in which the index pins are inserted.

20. The apparatus as claimed in claim 19, wherein the splicing tool further comprises a pusher plate hinged to the lower jaw to press the clip ribbon supported on the lower jaw, whereby the clip ribbon is brought into close contact with the lower jaw.

21. The apparatus as claimed in claim 17, further comprising:
a guide rail fixed on an upper surface of the frame perpendicular to a conveying direction of the carrier tape; and
a splicing tool slidably mounted onto the guide rail.

22. The apparatus as claimed in claim 18, further comprising:
a feeding sprocket rotatably fixed to the frame and formed with a plurality of pins formed on a circumferential surface at the same interval as that between the adjacent through holes of the clip of the clip ribbon to guide movement of the clip ribbon;
a fixed disc fixed to the frame to be coaxial with the feeding sprocket and formed with a plurality of grooves on a coaxial circle with the feeding sprocket on an outer surface thereof at regular intervals; and
a spin drum fixed between the feeding sprocket and the fixed disc to be concentric with the feeding sprocket and provided with a spring and a spin ball at a location thereof corresponding to the grooves of the fixed disc to allow the spin ball to be placed in the grooves of the fixed disc by means of an elastic force of the spring,
wherein the spin ball is placed in the next groove of the fixed disc when the feeding sprocket is rotated by an angular displacement from a groove to the next groove.

23. The apparatus as claimed in claim 18, further comprising elastic pressing means which is fixed to the frame and provides a frictional force to a side surface of the clip drum to prevent the clip drum from rotating by a rotational force below a predetermined limit.

24. The apparatus as claimed in claim 23, wherein the elastic pressing means comprises:
a housing formed with a through hole on an edge portion thereof in an axial direction and fixed to the frame to be positioned at a side surface of the clip drum;
a spring placed in the through hole;
a ball placed at an opening of the through hole such that a portion of the ball protrudes out of the housing by means of an elastic force of the spring to apply a certain force to the clip drum, and
an adjusting nut placed in the through hole to adjust the elastic force of the spring.

25. The apparatus as claimed in claim 24, wherein:
the cutter is fixed upward onto the lower jaw,
the upper jaw further comprise an elastic projection at a location corresponding to the cutter,
the lower jaw has index pins protruding upward from an upper surface thereof and inserted in the through holes of the clip, and
the upper jaw has inserting holes in which the index pins are inserted.

26. The apparatus as claimed in claim 25, further comprising a friction disc which us fixed to the frame and provides a frictional force to a side surface of the device drum to prevent the device drum from rotating by a rotational force below a predetermined limit.
